(19) United States
(12) Patent Application Publication
(10) Pub. No.: US 2023/0040315 A1
(43) Pub. Date: Feb. 9, 2023

(54) TECHNIQUES FOR AUTOMATED REVIEW-BASED INSIGHTS

(71) Applicant: eBay Inc., San Jose, CA (US)

(72) Inventor: Neeraj Gupta, Milpitas, CA (US)

(21) Appl. No.: 17/394,599

(22) Filed: Aug. 5, 2021

(51) Int. Cl. G06Q 30/02; G06Q 30/06; G06F 40/205; G06F 16/957

(52) U.S. Cl. CPC G06Q 30/0282; G06Q 30/0629; G06F 40/205; G06F 16/957

(57) ABSTRACT

Systems and methods for deriving relationships between user-submitted reviews are described. A system may identify a set of reviews for a first listing. The system may present the first listing including the set of reviews in a graphical user interface (GUI) of a client device, and receive, via the client device, a user input corresponding to text included in a first review from the set of reviews. The system may determine one or more additional listings based on textual similarity or dissimilarity between a portion of the text included in the first review and text included in one or more reviews for the one or more additional listings. The system may then present the one or more additional listings in the GUI of the client device.

### FIELD OF TECHNOLOGY

The present disclosure relates generally to database systems and data processing, and more specifically to techniques for automated review-based insights.

### BACKGROUND

User-submitted reviews are commonly used to make informed business and purchasing decisions for listings associated with products, services, and even product/service providers (e.g., sellers, businesses, entities). In the context of reviews for products, product reviews may be used to determine what features of a product are most desirable or useful, what features of the product have caused issues for other users, and so forth. Networked-based marketplaces may be able to improve a user's experience by recommending products to the user based on which products have favorable reviews or which products have features that are desirable to the user. Providing reviews associated with a given product or service may increase a likelihood of the user purchasing the product or service (or doing business with a seller or other entity), and may lead to an improved user experience.

In some cases, the user may desire to read through the user-submitted reviews personally to be able to make a more informed decision on which product to purchase, or which seller/entity to do business with. However, reading through a multitude of reviews may be a slow and tedious process. Some online marketplaces and retailers may attempt to assist a user with parsing through a large volume of user reviews by enabling the user to sort reviews using star-based filters which sort which reviews are presented to the user (e.g., 1-star reviews alone, 5-star reviews alone, etc.), or other techniques to reduce the number of reviews for the user to read through. However, these techniques may be deficient or may still result in the user having to read through many reviews to gain insight into which product the user should purchase, or which seller/entity to do business with.

### SUMMARY

A method for deriving relationships from user-submitted reviews is described. The method may include identifying, by one or more processors, a set of reviews for a first listing, causing presentation of the first listing in a graphical user interface (GUI) of a client device, the first listing comprising one or more reviews from the set of reviews, receiving, via the client device, a user input corresponding to text included in a first review from the set of reviews, determining, by the one or more processors, one or more additional listings based at least in part on textual similarity or dissimilarity between a portion of the text included in the first review and text included in one or more reviews for the one or more additional listings, and causing presentation of the one or more additional listings in the GUI of the client device.

An apparatus for deriving relationships from user-submitted reviews is described. The apparatus may include a processor, memory coupled with the processor, and instructions stored in the memory. The instructions may be executable by the processor to cause the apparatus to identify, by one or more processors, a set of reviews for a first listing, cause presentation of the first listing in a GUI of a client device, the first listing comprising one or more reviews from the set of reviews, receive, via the client device, a user input corresponding to text included in a first review from the set of reviews, determine, by the one or more processors, one or more additional listings based at least in part on textual similarity or dissimilarity between a portion of the text included in the first review and text included in one or more reviews for the one or more additional listings, and cause presentation of the one or more additional listings in the GUI of the client device.

Another apparatus for deriving relationships from user-submitted reviews is described. The apparatus may include means for identifying, by one or more processors, a set of reviews for a first listing, means for causing presentation of the first listing in a GUI of a client device, the first listing comprising one or more reviews from the set of reviews, means for receiving, via the client device, a user input corresponding to text included in a first review from the set of reviews, means for determining, by the one or more processors, one or more additional listings based at least in part on textual similarity or dissimilarity between a portion of the text included in the first review and text included in one or more reviews for the one or more additional listings, and means for causing presentation of the one or more additional listings in the GUI of the client device.

A non-transitory computer-readable medium storing code for deriving relationships from user-submitted reviews is described. The code may include instructions executable by a processor to identify, by one or more processors, a set of reviews for a first listing, cause presentation of the first listing in a GUI of a client device, the first listing comprising one or more reviews from the set of reviews, receive, via the client device, a user input corresponding to text included in a first review from the set of reviews, determine, by the one or more processors, one or more additional listings based at least in part on textual similarity or dissimilarity between a portion of the text included in the first review and text included in one or more reviews for the one or more additional listings, and cause presentation of the one or more additional listings in the GUI of the client device.

In some examples of the method, apparatuses, and non-transitory computer-readable medium described herein, selecting, by the one or more processors, a first subset of the set of reviews for the first listing based at least in part on textual similarity between at least the portion of the text included in the first review and text included in the first subset of the set of reviews and causing presentation of the first subset of the set of reviews in the GUI of the client device based at least in part on selecting the first subset of the set of reviews.

In some examples of the method, apparatuses, and non-transitory computer-readable medium described herein, the user input selects the portion of the text included in the first review related to a listing feature of the first listing, and selecting the first subset of the set of reviews may be based at least in part on textual similarity between the portion of the text included in the first review related to the listing feature and text included in the first subset of the set of reviews related to the listing feature.

In some examples of the method, apparatuses, and non-transitory computer-readable medium described herein, selecting, by the one or more processors, a second subset of the set of reviews for the first listing based at least in part on textual dissimilarity between at least the portion of the text included in the first review and text included in the second subset of the set of reviews and causing presentation of the second subset of the set of reviews in the GUI of the client device based at least in part on selecting the second subset of the set of reviews.

In some examples of the method, apparatuses, and non-transitory computer-readable medium described herein, generating, by the one or more processors, a representation score for the first review for the first listing, wherein the representation score indicates a proportion of the set of reviews which may be represented by the first review and causing presentation of the representation score for the first review in the GUI of the client device.

In some examples of the method, apparatuses, and non-transitory computer-readable medium described herein, generating, by the one or more processors, a representation score for each review of the set of reviews, wherein the representation scores indicate a proportion of the set of reviews which may be represented by each respective review, receiving, via the client device, an instruction to sort the one or more reviews based at least in part on the representation score for each of the one or more reviews, and causing presentation of the one or more reviews on the GUI of the client device based at least in part on receiving the instruction and the representation score for each review of the one or more reviews.

Some examples of the method, apparatuses, and non-transitory computer-readable medium described herein may further include operations, features, means, or instructions for causing presentation, in the GUI of the client device, an indication of a first quantity of reviews from the set of reviews that may be similar to the first review based at least in part on textual similarity between at least the portion of the text included in the first review and text included in the first quantity of reviews and causing presentation, in the GUI of the client device, an indication of a second quantity of reviews from the set of reviews that may be dissimilar to the first review based at least in part on textual dissimilarity between at least the portion of the text included in the first review and text included in the second quantity of reviews.

Some examples of the method, apparatuses, and non-transitory computer-readable medium described herein may further include operations, features, means, or instructions for transmitting the listing to the client device via a first response, wherein causing presentation of the listing in the GUI of the client device may be based at least in part on transmitting the first response and transmitting the one or more additional listings to the client device via a second response based at least in part on receiving the user input, wherein causing presentation of the one or more additional listings in the GUI of the client device may be based at least in part on transmitting the second response.

In some examples of the method, apparatuses, and non-transitory computer-readable medium described herein, the first listing may be associated with a product, a service, a business, a seller, a buyer, or an entity.

### BRIEF DESCRIPTION OF THE DRAWINGS

FIG. 1 illustrates an example of an automated review insights system that supports techniques for automated review-based insights in accordance with aspects of the present disclosure.

FIG. 2 illustrates an example of a system that supports techniques for automated review-based insights in accordance with aspects of the present disclosure.

FIG. 3 illustrates an example of a graphical user interface (GUI) that supports techniques for automated review-based insights in accordance with aspects of the present disclosure.

FIG. 4 illustrates an example of a GUI that supports techniques for automated review-based insights in accordance with aspects of the present disclosure.

FIG. 5 illustrates an example of a process flow that supports techniques for automated review-based insights in accordance with aspects of the present disclosure.

FIG. 6 shows a block diagram of an apparatus that supports techniques for automated review-based insights in accordance with aspects of the present disclosure.

FIG. 7 shows a block diagram of a review insight manager that supports techniques for automated review-based insights in accordance with aspects of the present disclosure.

FIG. 8 shows a diagram of a system including a device that supports techniques for automated review-based insights in accordance with aspects of the present disclosure.

FIGS. 9 through 11 show flowcharts illustrating methods that support techniques for automated review-based insights in accordance with aspects of the present disclosure.

### DETAILED DESCRIPTION

User-submitted reviews are commonly used to make informed business and purchasing decisions for products, services, and even product/service providers (e.g., sellers, businesses, entities). In the context of reviews for products, product reviews may be used to determine what features of a product are most desirable or useful, what features of the product have caused issues for other users, and so forth. Networked-based marketplaces may be able to improve a user's experience by recommending products to the user based on which products have favorable reviews or which products have features that are desirable to the user. Providing reviews associated with a given product or service may increase a likelihood of the user purchasing the product or service (or doing business with a seller or other entity), and may lead to an improved user experience.

In some cases, the user may desire to read through the user-submitted reviews personally to be able to make a more informed decision on which product to purchase, or which seller/entity to do business with. However, reading through a multitude of reviews may be a slow and tedious process. Some online marketplaces and retailers may attempt to assist a user with parsing through a large volume of user reviews by enabling the user to sort reviews using star-based filters which sort which reviews are presented to the user (e.g., 1-star reviews alone, 5-star reviews alone, etc.), to reduce the number of reviews for the user to read through. However, these techniques may be deficient or may still result in the user having to read through many reviews to gain insight into which product the user should purchase, or which seller/entity to do business with.

For example, some techniques may enable users to perform keyword searching throughout reviews for a product. However, for a user to determine whether a camera exhibits good indoor exposure quality, the user may have to perform a keyword search for “exposure” (and similar terms), and manually read through each review that mentions the term “exposure,” which may be an extremely slow and tedious process. Further, sorting reviews for a given camera by star ratings provided by the reviews for the camera may provide little insight as to the camera's indoor exposure quality, as many of the reviews may have provided high or low star ratings based on other features, such as picture quality, shutter speed, or durability.

Accordingly, aspects of the present disclosure are directed to techniques for deriving relationships between various reviews, comments, and feedback for listings (e.g., product listings, service listings, seller listings, business listings), where the derived relationships may be presented to a user to assist the user in effectively or quickly navigating through a multitude of reviews (e.g., reviews for a product, service, seller, business, entity). These techniques for deriving and highlighting the relationships between various reviews, comments, and feedback may be powered through various machine learning algorithms, natural language processing (NLP) algorithms, or similar algorithms.

Much of the present disclosure describes techniques for analyzing reviews for listings associated with products for the purposes of illustration and simplicity. However, this is not to be regarded as a limitation of the present disclosure. In this regard, the techniques described herein may be implemented in the context of reviews, comments, and other feedback for any type of listing, including listings for products, services, sellers, businesses, or entities. For example, aspects of the present disclosure may be implemented to provide review-based insights for reviews provided for different restaurants (e.g., retrieve reviews for restaurants which serve the same type of food and include similar/dissimilar reviews).

For the purpose of the present disclosure, the term “listing” may be used to refer to a webpage, advertisement, solicitation, or other data object which includes user-submitted reviews or feedback for underlying products, services, businesses, or other entities represented by the respective listing. For example, a listing may include a product or service listing for products/services which are available on a network-based marketplace. Moreover, a network-based marketplace may maintain a database of “seller listings” and “buyer listings” which enable users to submit reviews and other feedback for the sellers/buyers corresponding to the respective seller/buyer listings. By way of another example, a server or database may include restaurant listings for different restaurants which enables users to submit reviews, comments, and feedback for the restaurants associated with the corresponding restaurant listings.

In some aspects, techniques described herein may enable a user to highlight or select a portion of a review for a listing (e.g., product listing, service listing, business listing, seller listing), where the system is configured to identify other listings and/or other reviews which are similar or dissimilar to the respective listing or review based on a textual comparison of the highlighted portion of the review. For example, while viewing a review for a product listing, the user may select the entire text of the review or may highlight a portion of the text of the review, and a system may return a number of reviews for the user to view based on the selected or highlighted text using machine learning algorithms. In some examples, the system may return reviews that have similar text to the selected or highlighted text (e.g., similar reviews which reflect a similar sentiment to the highlighted text). Additionally or alternatively, the system may return reviews that have text that are opposite to the selected or highlighted text (e.g., dissimilar reviews which reflect a dissimilar sentiment to the highlighted text). Based on the similar and/or dissimilar reviews, the user may gain confidence whether the original review read by the user is a one-off review, or if the underlying product of the product listing is desirable to purchase with respect to the selected or highlighted text. In some cases, the system may calculate a confidence score (e.g., a percentage, a value between 0-1, etc.) between the original review read by the user and additional reviews retrieved by the system to indicate how similar or dissimilar the additional reviews are to the original review.

In some aspects, the system may be configured to identify additional listings (e.g., other product listings, other seller/buyer listings, other restaurant listings) that are better or worse than the currently viewed listing (e.g., auto-suggestion) based on reviews of the additional listings having more favorable or less favorable reviews compared to the selected or highlighted text of the review. For example, continuing with the example above, a user may select or highlight a portion of a review for a product. In this example, the system may determine other products which have similar and/or dissimilar reviews with respect to the highlighted text. Subsequently, the user may then be able to select between viewing those products that have similar reviews and/or those products that have dissimilar reviews, which may provide additional information and insights for enabling the user to make a more informed decision on which product to purchase. Similarly, in the context of listings for sellers or service providers, the system may identify listings for other sellers/providers which provide similar products/services and which have similar and/or dissimilar reviews with respect to the highlighted test.

Additionally, the system may provide other insights to the user by indicating how much one particular review exemplifies, or represents, the rest of the reviews for that same listing via a representation score (e.g., an indication of “represents X % of reviews” for each review). For example, reviews for a camera discuss ten features of the camera, where Review A describes eight of the ten features and Review B only discusses one of the ten features. In this example, Review A may exhibit a higher representation score as compared to Review B due to the fact that Review A discusses a wider range of features as compared to Review B. In some aspects, techniques described herein may enable the user to sort reviews by that representation score, which may allow the user to read those reviews that are most representative across all the reviews, thereby saving the user time in determining an overall or majority sentiment towards the listing.

Aspects of the disclosure are initially described in the context of an environment supporting an on-demand database service. Additional aspects of the disclosure are described in the context of graphical user interfaces (GUIs) and an example process flow. Aspects of the disclosure are further illustrated by and described with reference to apparatus diagrams, system diagrams, and flowcharts that relate to techniques for automated review-based insights.

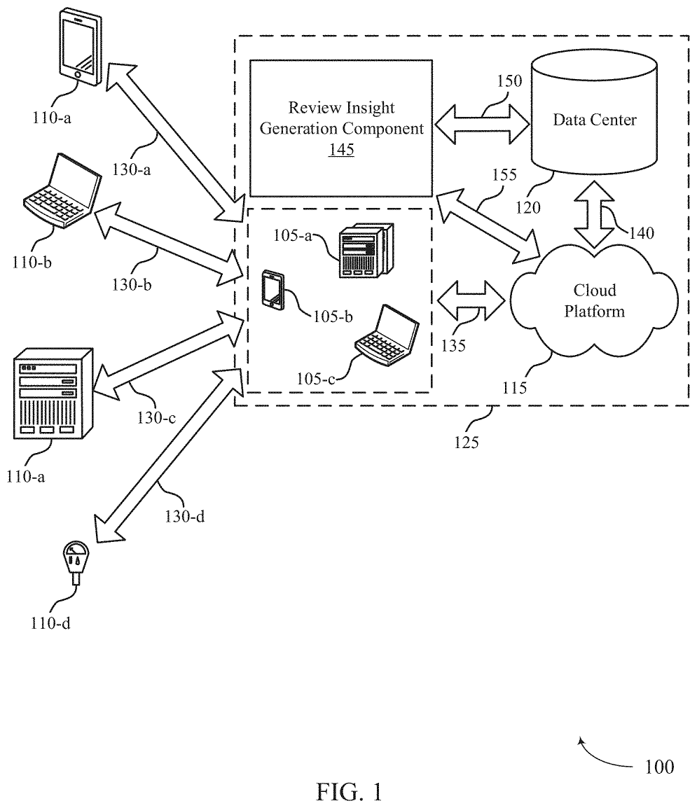

FIG. 1 illustrates an example of a system 100 for cloud computing that supports techniques for automated review-based insights in accordance with various aspects of the present disclosure. In some implementations, the system 100 may include, or may be configured to implement, a network-based marketplace (e.g., online marketplace). The system 100 includes cloud clients 105, client device 110 (e.g., “contact”), cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple client devices 110. The interactions 130 may include communications, opportunities, purchases, sales, or any other interaction between a cloud client 105 and a client device 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Client devices 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A client device 110 may also be referred to as a customer, a potential customer, a lead, a client, or some other suitable terminology. In some cases, the client device 110 may be an example of a user device, such as a server (e.g., client device 110-a), a laptop (e.g., client device 110-b), a smartphone (e.g., client device 110-c), or a sensor (e.g., client device 110-d). In other cases, the client device 110 may be another computing system. In some cases, the client device 110 may be operated by a user or group of users. The user or group of users may be associated with a business, a manufacturer, or any other appropriate organization.

In some aspects, users (e.g., client devices 110) may be associated with user accounts which enable the respective users/client devices 110 to access and interact with the cloud client 105 and/or platforms hosted by the cloud client 105, such as network-based marketplaces or other systems/servers. For example, a user may input user credentials (e.g., username, password, biometric data) into the client device 110 to login (or otherwise access) a user account associated with the user and/or client device 110, where the user account enables the user to access a network-based marketplace supported by the system 100.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support customer relationship management (CRM) solutions. This may include support for sales, service, marketing, community, analytics, applications, and the Internet of Things. Cloud platform 115 may receive data associated with client device interactions 130 from the cloud client 105 over network connection 135, and may store and analyze the data. In some cases, cloud platform 115 may receive data directly from an interaction 130 between a client device 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a client device 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may also include a review insight generation component 145. The review insight generation component 145 may communicate with cloud platform 115 via connection 155 and may also communicate with data center 120 via connection 150. The review insight generation component 145 may receive signals and inputs from client device 110 via cloud clients 105 and via cloud platform 115 or data center 120.

As noted previously herein, user-submitted reviews are commonly used to make informed business and purchasing decisions. Some online marketplaces and retailers may attempt to assist a user with parsing through a large volume of user reviews by enabling the user to sort reviews using star-based filters which sort which reviews are presented to the user (e.g., 1-star reviews alone, 5-star reviews alone, etc.), to reduce the number of reviews for the user to read through. However, these techniques may be deficient or may still result in the user having to read through many reviews to gain insight into which product the user should purchase, which restaurant a user should eat at, or which business/seller the user should interact with.

Accordingly, the review insight generation component 145 of the system 100 may be configured to generate automated review-based insights to improve review and listing suggestions provided to a user via a network-based marketplace, and improve overall user experience. In particular, the review insight generation component 145 may be configured to perform textual comparison between text included within reviews for listings (e.g., product listings, buyer/seller listings, restaurant listings, business listings) and within reviews across different listings in order to provide more helpful and insightful review and product suggestions to users. The review insight generation component 145 may be configured to receive reviews for products listed in a network-based marketplace which are submitted by users (e.g., submitted via client devices 110) in order to perform textual comparison across the respective reviews. Similarly, the review insight generation component 145 may be configured to receive reviews for listings associated with restaurants, businesses, sellers/buyers, or other entities maintained in a server or database which are submitted by users (e.g., submitted via client devices 110) in order to perform textual comparison across the respective reviews.

In some aspects, the review insight generation component 145 may compare entire reviews for a listing to one another to determine which reviews are similar to one another, and which reviews are dissimilar to one another. Additionally, or alternatively, the review insight generation component 145 may be configured to perform textual comparison across reviews at a finer granularity, such as a per-sentence basis, a per-user selection basis, or both. Performing textual comparison/analysis at a finer granularity may enable the review insight generation component 145 to identify other reviews which include sentences or portions of sentences are similar or dissimilar to the respective sentence or user-selected text. As such, the review insight generation component 145 may enable users to narrow down and focus in on reviews which discuss particular features or characteristics of a listing (e.g., product features, characteristics of a restaurant) which are most important to the user, which may facilitate better informed purchasing decisions.

For example, while viewing a review for a product via the client device 110-a, the user may select (e.g., highlight) a portion of text of the review. For instance, while viewing a review for a sweater, the user may highlight the sentence “it did not shrink in the wash.” In this example, the review insight generation component 145 may receive the user selection, and may identify other reviews for the product that have similar text to the selected or highlighted text (e.g., reviews which state that the sweater did not shrink in the wash) and/or other reviews that have text that are opposite or dissimilar to the selected or highlighted text (e.g., reviews which state that the sweater shrunk in the wash). The review insight generation component 145 may then provide the similar and dissimilar reviews to the user so that the user may view the similar/dissimilar reviews via a GUI of the client device 110-a. Based on the similar and/or dissimilar reviews, the user may gain confidence whether the original review read by the user (e.g., the original review which stated that “it did not shrink in the wash”) accurately represents other reviews for the sweater. By providing the user with reviews which include text that is similar and dissimilar to the highlighted portion of the original review, the review insight generation component 145 may enable the user to gain a better understanding as to whether or not the sweater will hold up in the wash without requiring the user to sort through large quantities of reviews.

In additional or alternative aspects, the review insight generation component 145 may identify other listings (e.g., other product listings, other business listings) which are similar or dissimilar to a selected product based on a textual comparison/analysis between reviews for the selected product. For example, continuing with the example above, the user may highlight the sentence “it did not shrink in the wash” within a review for the sweater. In this example, the review insight generation component 145 may receive the user selection, and may identify other products having similar text to the selected or highlighted text (e.g., other sweaters including reviews which state that the respective sweaters did not shrink in the wash) and/or other products having text that is opposite or dissimilar to the selected or highlighted text (e.g., other sweaters including reviews which state that the respective sweater shrunk in the wash). The review insight generation component 145 may then provide the similar products and dissimilar products to the user so that the user may view the similar/dissimilar products via a GUI of the client device 110-a. In this regard, the review insight generation component 145 may enable users to quickly and efficiently identify other products (e.g., other sweaters) which are more or less likely to exhibit certain features or characteristics which are important to the user (e.g., sweaters which will not shrink in the wash).

Techniques described herein may support automated review-based insights that may be used to improve a user's experience within a network-based marketplace. Techniques described herein may derive relationships between reviews and other feedback to provide more helpful and insightful reviews and listings to a user. Accordingly, the techniques for review-based insights described herein relates to computer technology and information processing, and overcomes a problems which arise in the context of GUIs (namely, efficiently sorting through and displaying large volumes of reviews via a GUI). Conventional review processing techniques may only provide basic sorting and keyword searching, which requires users to manually read through large volumes of reviews. As such, the techniques described herein amount to a specific improvement in the way computer analyze reviews by intelligently analyzing, searching, and retrieving similar/dissimilar reviews and listings (e.g., similar products, services, sellers, entities) to improve computer search operation. Taken together, aspects of the present disclosure provide techniques for review-based insights which improve the way computers operate and, more specifically, improve the way computers are able to organize, sort, filter, and analyze reviews in order to provide more helpful and insightful reviews to users.

In particular, techniques described herein may compare text across reviews for listings (e.g., product listings, service listings, business listings, buyer/seller listings) to identify similar and/or dissimilar reviews, as well as similar/dissimilar listings (e.g., similar/dissimilar products, sellers, or restaurants). In this regard, techniques described herein may enable users to quickly and efficiently sort through reviews based on features or characteristics which are important to the user, which may reduce a quantity of reviews the user must sort through, thereby improving overall user experience. Additionally, techniques described herein may improve listing recommendations which are provided to the user, which may improve a frequency and probability that the user will purchase recommended products, or interact with businesses or entities.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

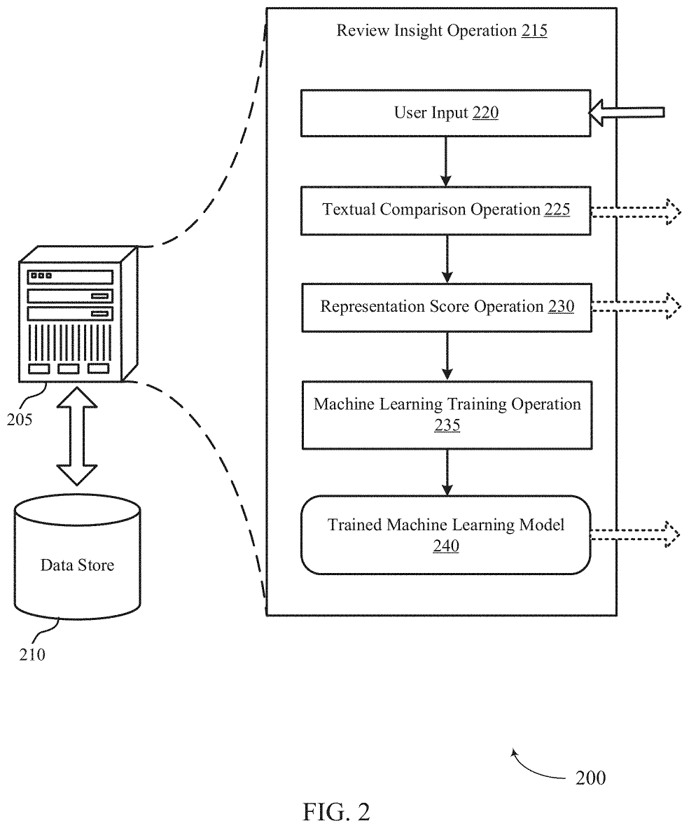

FIG. 2 illustrates an example of a system 200 that supports techniques for automated review-based insights in accordance with aspects of the present disclosure. The system 200 may include a device 205 (e.g., an application server or server system) and a data store 210. In some cases, the functions performed by the device 205 (such as application server) may instead be performed by a component of the data store 210. A user device (not shown) may support an application for a network-based marketplace (e.g., online marketplace). Specifically, a client device in combination with the device 205 may support an online marketplace that generates automated review-based insights, as described herein. In some implementations, an application (or an application hosting the network-based marketplace) may train a mathematical model (e.g., artificial intelligence model) at the device 205, where the device 205 may identify/generate a trained machine learning model 240 based on training data and using the trained data to generate review-based insights for different listings in the data store 210 (e.g., similar reviews, dissimilar reviews, similar listings, dissimilar listings). In some examples, the device 205 may provide the trained machine learning model 240 to an additional device (not shown).

According to one or more aspects of the present disclosure, a buyer may use a client device 110 to provide a search query for listings. For example, a buyer may provide a search query for listings of products listed on a network-based marketplace, and receive one or more search results based on the query. Specifically, the client device 110 may display an interactive interface for displaying an online marketplace and displaying one or more search results. In some examples, the client device 110 may include a mobile device, such as a smartphone, a laptop, a tablet, and the like. Additionally, a seller may use a client device 110 to upload a product listing for a product which is to be listed on the network-based marketplace. In some cases, the interface (e.g., GUI) at the client device 110 may run as a webpage within a web browser (e.g., as a software as a service (SaaS) product). In other cases, the interface may be part of an application downloaded onto the client device 110. A user (seller and/or buyer) operating the client device may input information into the user interface to log on to the network-based marketplace. In some cases, a user may be associated with a user account (e.g., user credential, user ID), and the user may log on to the network-based marketplace using the user account. For example, the user may input a username and password to access a user account associated with the user and/or client device 110, where the user account enables the user to access the network-based marketplace. In this example, each user (or client device 110) of the network-based marketplace may be associated with a user account which enables the respective user/client device 110 to access the network-based marketplace.

In some cases, the device 205 may train or develop a mathematical model or classifier (e.g., artificial intelligence model, a machine learning model, a neural network model, etc.) which is configured to provide automated review-based insights for listings (e.g., product listings in the data store 210, listings for restaurants cataloged in the data store 210). For example, the mathematical model may identify reviews which are similar or dissimilar to reviews or portions of reviews indicated by a user. Additionally, or alternatively, the mathematical model (e.g., trained machine learning model 240) may be configured to identify other listings (e.g., other products, sellers, businesses) which are similar or dissimilar to a listing being viewed by a user based on reviews or portions of reviews which are selected by the user. Thus, techniques described herein may be used to reduce a quantity of reviews which a user must sort through to make informed business and purchasing decisions. Moreover, by providing automated review-based insights, techniques described herein may provide more useful and contextual review and listing recommendations to the user, thereby improving overall user experience and increasing the probability that the user will make purchases within the network-based marketplace.

As part of training and developing the mathematical model configured for review-based insights, the device 205 may perform a review insight operation 215 as part of generating review-based insights for listings within the data store 210. Initially, the device 205 may receive a user input 220 from a client device 110. The user input 220 may include a selection or other indication of a review for a listing (e.g., listing for a product available on the network-based marketplace), a portion of the review, or both. For example, the user may highlight a sentence or a portion of a sentence of the review via a GUI of the client device. In some aspects, the user input 220 (e.g., selected text, highlighted text) may correspond to one or more characteristics or listing features (e.g., product features) of the listing which the user finds important. For example, in the case of a listing for a camera, a highlighted text may be associated with indoor exposure quality of the camera. By way of another example, highlighted text may be associated with a quality of food served by a restaurant, or the quality of the service at the restaurant.

The device 205 may perform a textual comparison operation 225 as part of the review insight operation 215. In particular, the device 205 may compare all or a portion of the review for the listing being viewed by the user (e.g., text indicated via the user input 220) to text included within other reviews for the listing. In this regard, the textual comparison operation 225 may perform textual comparison to identify similarities and differences across reviews for the respective listing. In some implementations, the textual comparison operation 225 may perform textual comparison across all reviews for the listing and/or without receiving the user input 220. In other words, the device 205 may be compared to perform textual comparison across reviews for a listing prior to (and without) receiving any user input 220 corresponding to text within a review. For example, the device 205 may perform the textual comparison operation 225 based on identifying/receiving a query for a listing (e.g., listing for a product listed in the network-based marketplace). In such cases, outputs of the textual comparison operation 225 may be delivered to the client device 110 via a first server response and/or along with the listing which are returned to the client device 110 responsive to a listing query.

In other cases, the device 205 may perform the textual comparison operation 225 based on receiving the user input 220. In particular, the device 205 may perform the textual comparison operation 225 to identify textual similarities and textual dissimilarities between the text indicated via the user input 220 and text included within other reviews for the same listing and/or other listing. In such cases, outputs of the textual comparison operation 225 may be delivered to the client device 110 via a second or additional server response which is separate from a server response which includes the listing which are returned to the client device 110 responsive to a listing query.

For example, the textual comparison operation 225 may identify other “similar reviews” for a product based on a textual similarity between at least a portion of the text indicated via the user input 220 and text included within other reviews for the product. Conversely, the textual comparison operation 225 may identify other “dissimilar reviews” for the product based on a textual dissimilarity between at least a portion of the text indicated via the user input 220 and text included within other reviews for the product. In this regard, the textual comparison operation 225 may be configured to identify reviews which are similar or dissimilar to the respective review with respect to the text indicated in the user input 220. The textual comparison operation 225 may output similar/dissimilar reviews (e.g., to a client device 110) so that the user may view how many reviews for the product are similar or dissimilar to the selected/highlighted text. By outputting similar and dissimilar reviews (and relative quantities of similar/dissimilar reviews), techniques described herein may provide the user with more confidence whether the selected portion of the review is a one-off review, or if the selected portion of the review accurately represents the sentiment across a large proportion of reviews.

Additionally, or alternatively, the textual comparison operation 225 may identify other listing which are similar or dissimilar to the current listing with respect to the text indicated via the user input 220 by performing a textual comparison between the text indicated via the user input 220 and text included within reviews for other listing. That is, the textual comparison operation 225 may identify other listing which exhibit similar/dissimilar features or characteristics as compared to the currently-viewed product with respect to the text indicated via the user input 220. In particular, the device 205 may perform the textual comparison operation 225 to identify textual similarities and textual dissimilarities between the text indicated via the user input 220 and text included within other reviews for other. For example, the textual comparison operation 225 may identify other “similar listing” based on a textual similarity between at least a portion of the text indicated via the user input 220 and text included within other reviews other listing. Conversely, the textual comparison operation 225 may identify other “dissimilar listing” based on a textual dissimilarity between at least a portion of the text indicated via the user input 220 and text included within other reviews for other listing.

In some aspects, when identifying similar/dissimilar listing based on textual similarity across reviews, the device 205 may be configured to identify products which are within a same product category as the product associated with the original search query and/or user input 220. For example, in cases where the user input 220 corresponds to a review for a baseball bat, the device 205 may identify other products which are similar/dissimilar by performing textual similarity comparison procedures across reviews for products within a “sporting equipment” category, a “baseball” sub-category, a “baseball bat” sub-category, and the like.

In some implementations, the device 205 may identify a listing category and/or listing feature for the listing (and/or a listing category from which similar/dissimilar listing will be identified) based on a listing category/product feature indicated via the original search query and/or user input 220. Additionally, or alternatively, the device 205 may identify the listing category and/or product feature with which similar/dissimilar listing will be identified by parsing a portion of the review indicated via the user input 220. In this regard, the device 205 may parse the text included within the user input 220 to identify a listing, a listing category, a listing feature, a sentiment of a listing and/or listing feature, or any combination thereof, and may subsequently identify similar/dissimilar listing based on the identified listing, listing categories, listing features, etc.

For example, the device 205 may parse text included within the user input 220 to identify a product feature of a product. For instance, the user input 220 may be associated with text of a review for a baseball bat which describes a durability of the wood of the baseball bat. In this example, the device 205 may parse the user input 220 to identify the product feature “wooden,” and may subsequently identify other baseball bats within a “baseball sporting equipment” product category (or other product category) which discuss wooden baseball bats. In particular, the device 205 may identify other baseball bats (e.g., other wooden baseball bats) within the identified product category which reflect similar or dissimilar sentiments regarding the durability of the wooden baseball bats.

The textual comparison operation 225 may perform textual comparison (e.g., identify textual similarity, textual dissimilarity) across reviews for listing using any number of textual analysis procedures, including semantic search/filtering techniques, machine learning modeling techniques, natural language processing techniques, and the like. For example, the textual comparison operation 225 may identify textual similarities by identifying reviews which include the same or similar words (e.g., synonyms) as text indicated via the user input 220. Conversely, the textual comparison operation 225 may identify textual dissimilarities by identifying reviews which include the different or opposite words (e.g., antonyms) as text indicated via the user input 220. The device 205 may be configured to utilize the sentiment for individual features within the review associated with the user input 220 to perform the textual comparison, as well as features, phrases, and synonyms/antonyms for words within the review and/or user input 220.

In some implementations, the device 205 may be configured to exclude or otherwise omit symbols, stop words, and other characters from the textual comparison procedures. In some cases, the device 205 may be configured to weight different features, characteristics, and/or words within the user input 220 when performing textual comparison. That is, the device 205 may place a greater weight or emphasis on one word/feature within the user input 220 when performing the textual comparison as compared to another word/feature.

The device 205 may perform a representation score operation 230 as part of the review insight operation 215. In some aspects, the representation score operation 230 is configured to generate a representation score for the review associated with the user input 220. The representation score may indicate how similar (or dissimilar) the respective review is relative to other reviews for the same listing. In other words, the representation score generated by the representation score operation 230 may indicate a proportion or percentage of reviews for the listing which are “represented” by the respective review (e.g., “Represents X % of reviews,” “This review represents X % of reviews for this product.”).

In some aspects, the representation score operation 230 may perform the representation score operation 230 based on an output or result of the textual comparison operation 225. That is, the representation score operation 230 may be configured to generate a representation score for the review associated with the user input 220 based on textual similarities/dissimilarities across reviews for the listing, as determined by the textual comparison operation 225.

In some aspects, the representation score operation 230 may be configured to generate the representation score based on identifying a quantity of features or characteristics which are covered/mentioned by the reviews for the listing, and identifying a percentage or proportion of the features/characteristics which are covered/mentioned by the review associated with the user input 220. In other words, the device 205 may combine important points (e.g., important features/characteristics) for all the reviews for a given listing, and may generate a representation score for each review which indicates what percentage of those important points are reflected in a given review. For example, if reviews for a camera discuss ten important features (e.g., frame rate, picture quality, etc.), a review which discusses eight out of the ten important features may have a higher representation score as compared to a review which only discusses two out of the ten important features.

Additionally, or alternatively, the representation score operation 230 may generate the representation score based on how similar (or dissimilar) sentiments with respect to different features/characteristics are relative to other reviews for the listing. In other words, if a vast majority of reviews indicate that a camera produces pictures with great quality (e.g., positive sentiment), a review which states “poor quality, poor value” (e.g., negative sentiment) may represent just 2% of the reviews, in that it reflects a different sentiment (e.g., poor quality pictures) as compared to the sentiment reflected by the vast majority of reviews for the camera (e.g., high quality pictures).

In effect, by generating representation scores for respective reviews, the representation score operation 230 may enable users to know whether the review they are reading is representative (or not) of other reviews for the same listing. As such, techniques described herein may enable users to reduce a quantity of reviews that they sort through. For example, if a review has a 95% representation score, a user may be confident that the review is highly representative of other reviews for the listing, and may therefore skip reading other reviews for the product (e.g., the review is highly representative of the underlying product, business, or entity of the listing). As will be described in further detail herein, a user may be able to sort or filter reviews for a listing based on the representation scores output by the representation score operation 230.

In some implementations, any of the operations/procedures performed by the device 205 (e.g., textual comparison operation 225, representation score operation 230) may be performed by a machine learning classifier, NLP algorithm, or other algorithm/classifier. In this regard, the device 205 may be configured to perform a machine learning training operation 235 which is configured to generate and train the trained machine learning model 240. In particular, outputs from the textual comparison operation 225 (e.g., identified textual similarities, identified textual dissimilarities) and/or the representation score operation 230 (e.g., generated representation scores) may be input into the machine learning training operation 235 to facilitate training of the trained machine learning model 240.

In some implementations, the machine learning training operation 235 may utilize other inputs to train/generate the trained machine learning model 240, such as other inputs from the user or other users. For example, upon being provided with other reviews which are similar/dissimilar to the text indicated in the user input 220, a user may be able to indicate whether the provided reviews were helpful, and/or if the provided reviews are actually similar/dissimilar to the text in the user input 220. In this regard, the machine learning training operation 235 may be configured to utilize additional user inputs to further train the trained machine learning model 240.

In this regard, the machine learning training operation 235 may generate the trained machine learning model 240 to enable the trained machine learning model 240 to perform textual comparison across reviews (e.g., identify textual similarities/dissimilarities), generate representation scores, and the like. Thus, in some implementations, the trained machine learning model 240 may be configured to receive user inputs 220, perform textual comparison analysis procedures, identify/output recommended similar/dissimilar reviews based on textual comparisons, identify/output recommended similar/dissimilar listing based on textual comparisons, generate/output representation scores, and the like.

In some cases, the machine learning training operation 235 may implement the textual comparison operation 225, where the machine learning training operation 235 is trained using a set of test reviews for identifying one or more reviews that are similar, dissimilar, or both. Once trained, a user selection of a particular review, or text from a particular review, from a listing (e.g., product listing on the network-based marketplace) may be provided to the machine learning model, and the device 205 performing the textual comparison operation 225 on a corpus of review listings to identify one or more reviews that are similar, dissimilar, or both to the particular review or the text from the particular review.

Techniques supported by the system 200 may support automated review-based insights that may be used to improve user experience when sorting through reviews for listings (e.g., listings for products on a network-based marketplace, listings for restaurants cataloged on a server or database). Techniques described herein may derive relationships between reviews and other feedback to provide more helpful and insightful reviews and listing to a user. In particular, techniques described herein may compare text across reviews for listing to identify similar and/or dissimilar reviews, as well as similar/dissimilar listing. In this regard, techniques described herein may enable users to quickly and efficiently sort through reviews based on features or characteristics which are important to the user (e.g., product durability, quality service, quality food), which may reduce a quantity of reviews the user must sort through, thereby improving overall user experience. Additionally, techniques described herein may improve listing recommendations which are provided to the user, which may improve a frequency and probability that the user will purchase recommended products, interact with buyers/sellers, or eat at a restaurant.

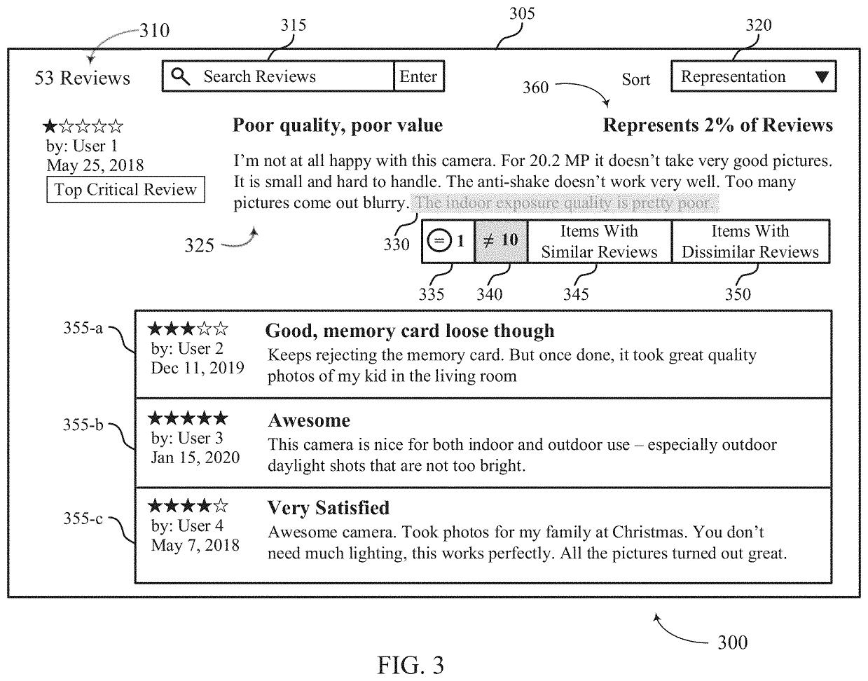

FIG. 3 illustrates an example of a GUI 300 that supports techniques for automated review-based insights in accordance with aspects of the present disclosure. The GUI 300 illustrated in FIG. 3 may implement, or be implemented by, aspects of system 100, system 200, or both. For example, the GUI 300 may include an example of a GUI of a client device 110 illustrated in FIG. 1.

The GUI 300 illustrates an application page 305 which may be displayed to a user via a client device 110. The application page 305 illustrates examples of some review-based insights which may be provided to a user, as described herein. The application page 305 may include a product listing for a product available to purchase via a network-based marketplace and the product listing may include a set of one or more user provided product reviews for the product. For example, when viewing a product listing for a camera available for purchase via a network-based marketplace, the application page 305 may display a quantity of a set of reviews 310 which have been received for the camera from other purchasers of the camera.

While the GUI 300 shown in FIG. 3 illustrates an application page 305 for a listing of a product, this is not to be regarded as a limitation of the present disclosure. In this regard, aspects of application page 305 (e.g., GUI elements, search functionality, representation scores, similar/dissimilar reviews, similar/dissimilar listings) may be applied in the context of other types of listings, including listings for services, businesses (e.g., restaurants), buyers/sellers, and the like.

The application page 305 may include a search bar 315 which may enable the user (e.g., a prospective buyer) to search through the set of reviews 310 using keyword searches. The application page 305 may also include a filtering element 320 which may enable the user to filter or sort the set of reviews 310 according to various parameters, such as overall score (e.g., only 1-star reviews, only 5-star reviews), representation scores (e.g., representation score 360), length of review, date of review, and the like.

Upon receiving a user selection of a review 325 from the set of reviews 310 for the product, the GUI 300 may display the selected review 325. For example, as shown in FIG. 3, the application page 305 may display the review 325 titled “Poor quality, poor value,” along with the text of the review 325. The application page 305 may also display additional information associated with the review 325, such as a name (e.g., username) of the user who submitted the review, a score of the review (e.g., 1/5 stars), a date that the review was submitted, and the like. In some implementations, the application page 305 may display one or more “tags” associated with the review. The tags may indicate whether the review is positive or negative (e.g., overall sentiment of the review), whether others have found the review to be helpful, and the like. For instance, as shown in FIG. 3, the application page 305 includes a tag which states “Top Critical Review,” indicating that the review 325 is the review from the set of reviews 310 which is most critical of the camera being viewed.

The application page 305 may indicate a representation score 360 for the review 325. As described previously herein, the representation score 360 may indicate a proportion or percentage of the set of reviews 310 which are represented by the review 325. For instance, as shown in FIG. 3, the representation score 360 for the review indicates that the review 325 “represents 2% of reviews” out of the set of reviews 310 for the item. By displaying the representation score 360, a user may be able to quickly identify whether the review 325 accurately represents other reviews for the respective product, or if the review is a one-off review that is not representative of the other reviews and/or product.

In some implementations, a user may be able to sort or filter the set of reviews 310 based on the representation scores 360 for the respective reviews. For example, the user may be able to utilize the filtering element 320 to filter/sort the set of reviews 310 based on one or more features or characteristics of the reviews within the set of reviews 310, including a representation score 360 for each review (e.g., highest to lowest representation score). Many reviews for a product may discuss the same features, and may exhibit similar sentiments (e.g., good/bad). Thus, there may be a significant amount of overlap across reviews. As such, by enabling users to sort/filter reviews by representation score 360, techniques described herein may enable users to view reviews which are more representative of the set of reviews 310, thereby reducing a quantity of reviews that the user may read through when making a purchasing decision.

In some cases, the user may be viewing cameras which are available on the network-based marketplace to take indoor family photographs. As shown in FIG. 3, the user may select the review 325 (e.g., “Poor quality, poor value”) which discusses picture quality for indoor photographs. The review 325 illustrated in FIG. 3 indicates that the camera may not be great for indoor photographs based on the sentence “The indoor exposure quality is pretty poor.” However, the user may not know whether this is a one-off review, or whether other users also believe that this camera is not great for indoor pictures. According to some conventional techniques, the user may be required to read through large quantities of reviews to identify other reviews which discuss indoor picture quality to gain a sense as to whether or not the camera is good for indoor photographs. However, the review-based insights techniques described herein may facilitate this process for the user, and may reduce a time the user spends reading through reviews.

For example, in order to gain more insight regarding indoor exposure quality and indoor picture quality, the user may select or highlight the sentence discussing indoor exposure quality within the review 325, as illustrated via the text selection 330. Upon indicating the text selection 330 or selecting some action element (e.g., a “Generate Insights” button), the client device 110 may transmit a user input to a server, where the user input indicates the text of the review 325 corresponding to the text selection 330. The servers may then be compared to perform textual analysis techniques described herein. In particular, the servers may be configured to identify reviews which are similar to the text selection 330 based on a textual similarity between the text selection 330 and text within other reviews for the product, and/or reviews which are dissimilar to the text selection 330 based on a textual dissimilarity between the text selection 330 and text within other reviews for the product.

As shown in application page 305, the GUI 300 of the client device 110 may display a similar reviews indicator 335 (indicated via the “=” sign), and a dissimilar reviews indicator 340 (indicated via the “≠” sign). The similar reviews indicator 335 may indicate a quantity of reviews from the set of reviews 310 for the product which include text that is similar to the text selection 330. In other words, as shown in application page 305, the set of reviews 310 may include one other review which also indicates that the camera exhibits poor indoor exposure quality. Conversely, the dissimilar reviews indicator 340 may indicate a quantity of reviews from the set of reviews 310 for the product which include text that is dissimilar to the text selection 330. In other words, as shown in application page 305, the set of reviews 310 may include ten other reviews which disagree that the camera exhibits poor indoor exposure quality (e.g., reviews which may indicate good indoor exposure quality). By displaying quantities of reviews which are either similar or dissimilar to the text selection 330, techniques described herein may enable the user to quickly determine that this review 325 may not be representative of the camera's indoor exposure quality. In particular, due to the fact that there is only one other review which is similar to the text selection 330 and ten other reviews which are dissimilar to the text selection 330, the user may quickly determine that it is more likely that the camera exhibits good indoor exposure quality.

In some aspects, a user may be able to select the similar reviews indicator 335 or the dissimilar reviews indicator 340 to view other reviews which are similar or dissimilar, respectively, relative to the text within the text selection 330. For example, upon selecting the dissimilar reviews indicator 340, the application page 305 may display other reviews 355 for the product which are dissimilar to the text selection 330 (e.g., reviews 355 which indicate good indoor exposure quality, or otherwise disagree with the camera having poor indoor exposure quality). For instance, upon selecting the dissimilar reviews indicator 340, the application page 305 may display reviews 355-a, 355-b, and 355-c. The reviews 355 may include reviews for the same product as the review 325 which were submitted by other users, and which include text which is dissimilar to the text selection 330. For example, the review 355-a is dissimilar to the text selection 330 by stating “it took great quality photos of my kid in the living room.” Since the highlighted text within the text selection 330 is part of the review 325 for the camera, the results for similar/dissimilar reviews are very contextual. Moreover, as described previously herein, the system may be configured to utilize the sentiment for individual features within the review 325 to perform the textual comparison, as well as features, phrases, synonyms, antonyms, or any combination thereof, for words within the review 325 and/or text selection 330.

In some implementations, the application page 305 may display a “confidence score” or “confidence metric” associated with each review 355. Confidence scores calculated by the system may indicate how confident the system is that each respective review 355 is similar or dissimilar to the text selection 330. In other words, confidence scores may represent a likelihood that retrieved reviews 355 are actually similar or dissimilar to the text selection 330. For example, in some cases, each review 355-a, 355-b, and 355-c may indicate a confidence score which indicates a confidence that each respective review 355 is dissimilar to the text selection 330. Confidence scores may be indicated using any ranking or evaluation technique known in the art, including percentages, ranges of values (e.g., between 0 and 1, or between 0 and 10), and the like. For example, the second review 355-b may be associated with a confidence score of 0.8, where the third review 355-c may be associated with a confidence score of 0.3, thereby indicating that the system is more confident that the second review 355-b is dissimilar to the text selection 330 as compared to the third review 355-c.

In cases where the user does not indicate text which is to be used to identify similar/dissimilar reviews and/or similar/dissimilar products, the system may be configured to perform textual analysis based on the entirety of the review 325. In other words, in cases where the user does not indicate the text selection 330, the system may be configured to identify reviews which are similar or dissimilar to the entirety of the review 325.

As shown in application page 305, the GUI 300 of the client device 110 may also indicate a similar products indicator 345 and a dissimilar products indicator 350. The similar products indicator 345 may indicate a quantity of other products which include reviews having text that is similar to the text selection 330. The similar products indicator 345 may indicate a quantity of other products which include reviews having text that is similar to the text selection 330. In other words, the similar products indicator 345 may indicate a quantity of other cameras which include reviews which agree that the respective cameras exhibit poor indoor exposure quality (e.g., other cameras including reviews indicating poor indoor exposure quality). Conversely, the dissimilar products indicator 350 may indicate a quantity of other products which include reviews having text that is dissimilar to the text selection 330. In other words, the dissimilar products indicator 350 may indicate other cameras which include reviews which disagree that the respective cameras exhibit poor indoor exposure quality (e.g., other cameras including reviews indicating good indoor exposure quality).

In some implementations, the application page 305 may indicate quantities of similar and dissimilar products which are associated with the similar products indicator 345 and the dissimilar products indicator 350, respectively. Further, in cases where the user does not indicate text which is to be used to identify similar/dissimilar reviews and/or similar/dissimilar products, the system may be configured to perform textual analysis based on the entirety of the review 325. In other words, in cases where the user does not indicate the text selection 330, the system may be configured to identify other products which are similar or dissimilar to the original product based on the entirety of the review 325.

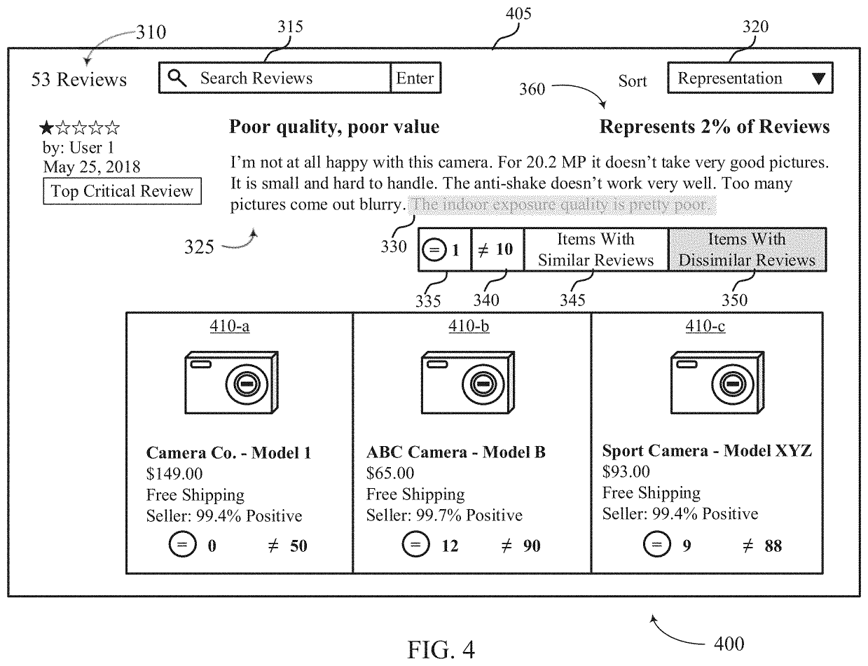

Review-based insights associated with the identification of similar and dissimilar products may be further shown and described with reference to FIG. 4.

FIG. 4 illustrates an example of a GUI 400 that supports techniques for automated review-based insights in accordance with aspects of the present disclosure. The GUI 400 illustrated in FIG. 4 may implement, or be implemented by, aspects of system 100, system 200, or both. For example, the GUI 400 may include an example of a GUI of a client device 110 illustrated in FIG. 1. As noted previously herein, the GUI 400 shown in FIG. 4 illustrates an application page 405 for a listing of a product. However, this is not to be regarded as a limitation of the present disclosure. In this regard, aspects of application page 405 (e.g., GUI elements, search functionality, representation scores, similar/dissimilar reviews, similar/dissimilar listings) may be applied in the context of other types of listings, including listings for services, businesses (e.g., restaurants), buyers/sellers, and the like.

The GUI 400 illustrates an application page 405 which may be displayed to a user via a client device 110. In some implementations, the application page 405 illustrated in FIG. 4 may include similar features, components, and elements as compared to the application page 305 illustrated in FIG. 3. In this regard, any discussion of the application page 305 illustrated in FIG. 3 may be regarded as applying to the application page 405 illustrated in FIG. 4, to the extent applicable.

The application page 405 illustrates examples of some review-based insights which may be provided to a user, as described herein. More specifically, the application page 405 may be presented to a user via the GUI 400 (e.g., GUI of a client device 110) upon selection of the dissimilar products indicator 350, as shown in FIGS. 3 and 4. For example, upon selecting the dissimilar products indicator 350 in application page 305 as shown in FIG. 3, a client device 110 may display the application page 405 shown in FIG. 4.

As described previously herein, the system may identify similar products (e.g., products associated with the similar products indicator 345) and dissimilar products (e.g., products associated with the dissimilar products indicator 350) based on a textual comparison of text included within the user selection 330 and text included within reviews for other similar/dissimilar products. In some aspects, when identifying similar/dissimilar products based on textual similarity across reviews, the system (e.g., servers, device 205) may be configured to identify products which are within a same product category as the product associated with the original search query, the original review 325, and/or text selection 330. For example, in cases where the text selection 330 corresponds to the review 325 for a camera, the system may identify other products (e.g., other cameras) which are similar/dissimilar by performing textual similarity comparison procedures across reviews for products within a “photography” category, or other related category.

For example, the system may identify a product category and/or product feature which will be used to identify similar/dissimilar products based on a product category/product feature indicated via the original search query (e.g., original search query associated with review 325). Additionally, or alternatively, the system may identify the product category and/or product feature with which similar/dissimilar products will be identified by parsing a portion of the review 325 indicated via the text selection 330. In this regard, the system may parse the text included within the text selection 330 to identify a product, a product category, a product feature, a sentiment of a product and/or product feature, or any combination thereof, and may subsequently identify similar/dissimilar products based on the identified products, product categories, product features, etc. In particular, upon identifying a product feature from the text selection 330, the system may identify other products (e.g., other cameras) which exhibit the same product feature, which are within a same product category, or both, which include reviews that reflect similar or dissimilar sentiments with respect to the identified product feature.

In addition to, or in the alternate to, parsing the text included within the text selection 330 to identify product features and/or product categories used to identify similar/dissimilar products, the system may utilize one or more words (e.g., key words) from the original search query to identify similar/dissimilar products. For example, when inputting the original search query for cameras, the user may input the phrase “digital single-lens reflex (DSLR) camera.” In this example, the system may utilize the phrase “DSLR” to identify a product feature (e.g., DSLR feature) and/or a product category (e.g., DSLR cameras) which will be used to identify similar/dissimilar products which exhibit the respective product feature and/or are included within the respective product category. Additionally, the system may parse the text selection 330 to identify the product feature “indoor exposure quality” to further refine identified similar/dissimilar products which include the identified product feature (e.g., DSLR feature), are included within the identified product category (e.g., DSLR cameras), and/or include reviews which discuss the product feature which was identified within the text selection 330 (e.g., indoor exposure quality).

Reference will again be made to FIG. 4. Upon selection of the dissimilar products indicator 350, the application page 405 may display one or more other products which are dissimilar to the original product with respect to the text selection 330. For example, as shown in FIG. 4, the application page 405 may display other cameras (e.g., products 410-a, 410-b, 410-c) which include reviews including text that is dissimilar to the text selection 330. In other words, the application page 405 may display other products 410 which include reviews that express that the respective cameras exhibit good indoor exposure quality.

In some aspects, each product 410 may illustrate a picture of the respective product, a title, a price, seller information (e.g., seller reputation or rating), and the like. Further, in some implementations, each product 410 may indicate how a quantity of reviews for the respective product which are similar or dissimilar to the text selection 330. For example, the product 410-a (e.g., Model 1 camera made by Camera Co.) does not include any reviews which are similar to the text selection 330 (e.g., does not include any reviews indicating poor indoor exposure quality), and includes fifty reviews which are dissimilar to the text selection 330 (e.g., fifty reviews indicating good indoor exposure quality, or otherwise disagreeing with the text selection 330). Upon selection of the similar products indicator 335, the application page 405 may display one or more other products which are similar to the original product with respect to the text selection 330.

By displaying other products 410 (e.g., other cameras) which include reviews which are similar or dissimilar to the text selection 330, techniques described herein may enable users to make more informed purchasing decisions. In particular, by identifying products 410 which are similar/dissimilar to selected features or characteristics, techniques described herein may enable users to quickly and efficiently find products which exhibit features or characteristics which are important to each respective user (e.g., find cameras which exhibit good indoor exposure quality).

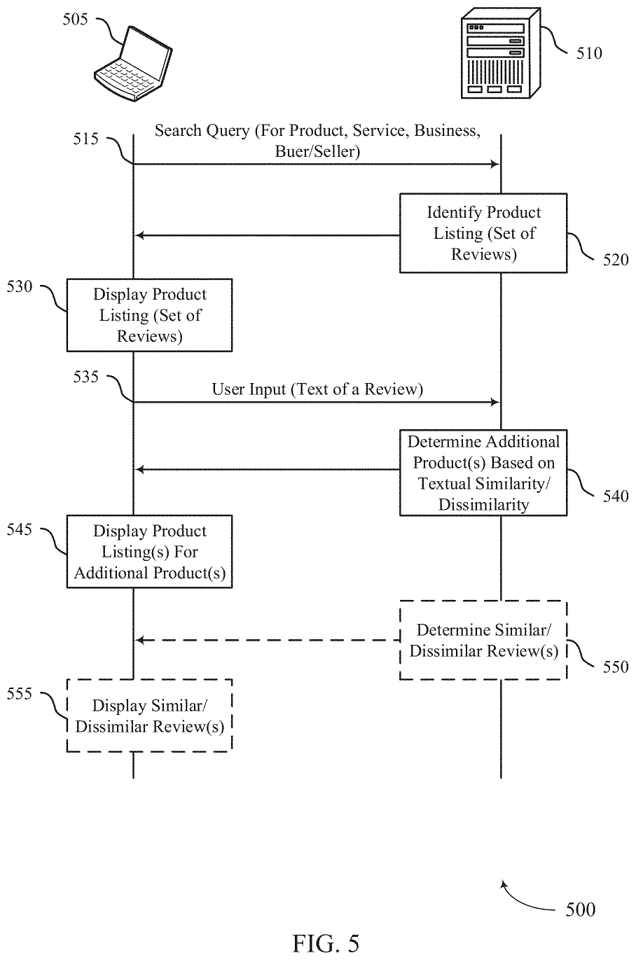

FIG. 5 illustrates an example of a process flow 500 that supports techniques for automated review-based insights in accordance with aspects of the present disclosure. The process flow 500 may implement, or be implemented by, aspects of the system 100, the system 200, the GUI 300, the GUI 400, or any combination thereof. For example, process flow 500 may include a client device 505 and an application server 510, which may represent corresponding client devices and application servers as described with reference to FIGS. 1-4.

In the following description of the process flow 500, the operations between the client device 505 and the application server 510 may be performed in different orders or at different times. Certain operations may also be left out of the process flow 500, or other operations may be added to the process flow 500. It is to be understood that while the client device 505 and the application server 510 are shown performing a number of the operations of process flow 500, any device may perform the operations shown.

Furthermore, while the steps/functions of process flow 500 are described in the context of product listings, the various steps/functions shown and described in process flow 500 may additionally or alternatively be applied in the context of other types of listings, including listings for services, businesses (e.g., restaurants), buyers/sellers, and the like.

At 515, the client device 505 may transmit a query (e.g., search) for a listing. For example, the client device 505 may transmit a query for a product listed on a network-based marketplace to the application server 510 (e.g., query for product listing). For instance, a user may input a search for a product via the client device 505 (e.g., via a GUI of the client device), where the client device 505 is configured to transmit the query to the application server 510 in response to receiving the user input.

At 520, the application server 510 may identify one or more product listings for one or more products available on the network-based marketplace, and may transmit the one or more product listings to the client device 505. In some aspects, the one or more product listings may be transmitted to the client device via a first server response. In some aspects, the application server 510 may identify and transmit the product listings at 520 based on (e.g., in response to) receiving the query at 515. For example, upon receiving a query for a camera at 515, the application server 510 may identify multiple product listings for cameras which match the query.

In some aspects, the application server 510 may be configured to identify a set of reviews for each product and/or each product listing of the network-based marketplace. In other words, each product listing may include a set of reviews for the respective product. For example, a first product listing for a first camera may include a set of user-submitted reviews for the first camera, where a second product listing for a second camera may include a second set of user-submitted reviews for the second camera.

At 530, the client device 505 may display the product listings received from the application server 510 on a GUI of the client device 505. For example, after transmitting a query for a camera at 515, the GUI of the client device 505 may display a set of product listings for cameras which are listed on the network-based marketplace. In some aspects, the application server 510 may cause presentation of the product listings on the client device 505 by transmitting the product listings to the client device 505 at 520 along with an instruction for the client device 505 to display the product listings.

At 535, the client device 505 may transmit a user input to the application server 510. In some aspects, the user input corresponds to text included in a review of a product listing which was transmitted to the client device 505 at 520 and/or displayed on the client device 505 at 530. In some aspects, the text corresponding to the user input may be associated with or describe a characteristic of the product, a product feature, or both.

For example, a user may select a product listing for a product displayed on the client device 505, and may subsequently select (e.g., highlight) text included in a review for the product which is associated with the product listing. For instance, a user may select, or highlight, an entirety of the review for the product, one or more sentences of the review, a portion of a sentence of the review, and the like. In this example, the user input (e.g., the selection of text in the review) may be transmitted to the application server 510 such that the application server 510 may generate automated review-based insights based on the indicated (e.g., selected, highlighted) text.

At 540, the application server 510 may determine one or more additional listings (e.g., one or more additional products which are available on the network-based marketplace) based on the user input received at 535. Moreover, at 540, the application server 510 may transmit product listings for the identified listings/products to the client device 505. In some aspects, the application server 510 may transmit the identified additional products to the client device 505 via a second server response. For example, the application server 510 may transmit the product listings at 520 via a first server response, and may transmit the additional identified products at 540 via a second server response.

In particular, the application server 510 may determine one or more similar products and/or dissimilar products based on a textual similarity or textual dissimilarity, respectively, between the text associated with the user input and text included within reviews of products available on the network-based marketplace. In other words, in cases where the text indicated in the user input discusses a product feature or characteristic for the product, the application server 510 may determine products which exhibit similar product features/characteristics according to reviews (e.g., similar products), products which exhibit dissimilar product features/characteristics according to reviews (e.g., dissimilar products), or both.

For example, the user input transmitted/received at 535 may correspond to the phrase “great quality pictures” in a review for a camera. In this example, the application server 510 may identify one or more other cameras available on the network-based marketplace which are also believed to take high-quality pictures based on a textual similarity between the text “great quality pictures” and text included within reviews for the other cameras that were submitted by other users. In other words, the application server 510 may identify other cameras which also include reviews submitted by other users that discuss high-quality pictures. In this regard, the application server 510 may identify cameras which are similar to the camera being viewed with respect to the phrase “great quality pictures” (e.g., other cameras which take great quality pictures, according to reviews).

Continuing with the same example, the application server 510 may identify one or more other cameras available on the network-based marketplace which are dissimilar to the camera (e.g., also believed to take low-quality pictures) based on a textual dissimilarity between the text “great quality pictures” and text included within reviews for other cameras. In other words, the application server 510 may identify other cameras which include reviews that discuss low-quality pictures. In this regard, the application server 510 may identify cameras which are dissimilar to the camera being viewed with respect to the phrase “great quality pictures” (e.g., other cameras which take low quality pictures, according to reviews).

At 545, the client device 505 may display the additional listings (e.g., additional product listings) which were received at 540. For example, as shown in FIG. 4, a GUI 400 of the client device 505 may display products 410-a, 410-b, and 410-c which were identified by the application server 510.

At 550, the application server 510 may determine one or more additional reviews for the listing/product associated with the user input received at 535. Moreover, at 550, the application server 510 may transmit the additional reviews (e.g., similar reviews, dissimilar reviews) to the client device 505. In some aspects, the application server 510 may transmit the identified reviews to the client device 505 via an additional server response. For example, the application server 510 may transmit the product listings at 520 via a first server response, and may transmit the similar/dissimilar reviews identified at 550 via a second server response. Additionally, or alternatively, similar/dissimilar reviews identified at 550 may be transmitted in a same server response as the similar/dissimilar products identified at 540.

In particular, the application server 510 may determine reviews which are similar or dissimilar to the text indicated via the user input received at 535 based on a textual similarity or textual dissimilarity, respectively, between the text associated with the user input and text included within other reviews for the same product. In other words, in cases where the text indicated in the user input discusses a product feature or characteristic for the product, the application server 510 may determine other reviews for the product which exhibit similar or dissimilar sentiments with respect to the indicated product feature or characteristic.

For example, the user input transmitted/received at 535 may correspond to the phrase “great quality pictures” in a review for a camera. In this example, the application server 510 may identify one or more other reviews for the camera which include reviews discussing high-quality pictures based on a textual similarity between the text “great quality pictures” and text included within other reviews the camera. In other words, the application server 510 may identify other reviews which state that the camera takes high-quality pictures. Continuing with the same example, the application server 510 may identify one or more other reviews for the camera which include reviews discussing low-quality pictures based on a textual similarity between the text “great quality pictures” and text included within other reviews the camera. In other words, the application server 510 may identify other reviews which state that the camera takes low-quality pictures, or reviews which otherwise disagree with the statement “great quality pictures.”

At 555, the client device 505 may display other reviews for the product associated with the user input which were received at 550. For example, as shown in FIG. 3, a GUI 300 of the client device 505 may display other reviews 355-a, 3555-b, and 355-c which were identified by the application server 510 as including text that is similar or dissimilar to the text included within the user input received at 535.

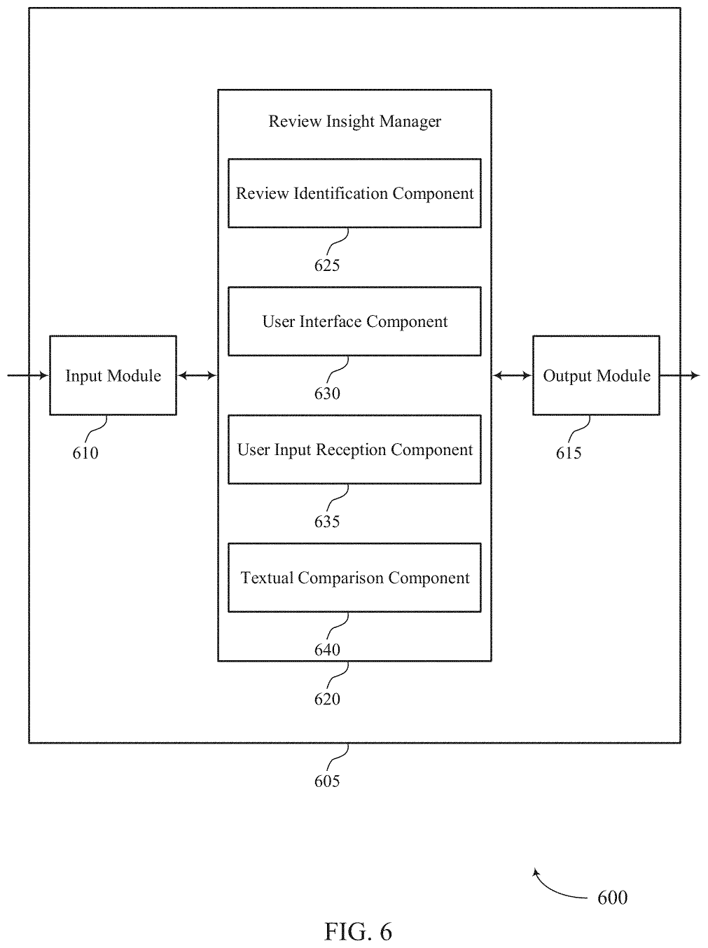

FIG. 6 shows a block diagram 600 of a device 605 that supports techniques for automated review-based insights in accordance with aspects of the present disclosure. The device 605 may include an input module 610, an output module 615, and a review insight manager 620. The device 605 may also include a processor. Each of these components may be in communication with one another (e.g., via one or more buses).

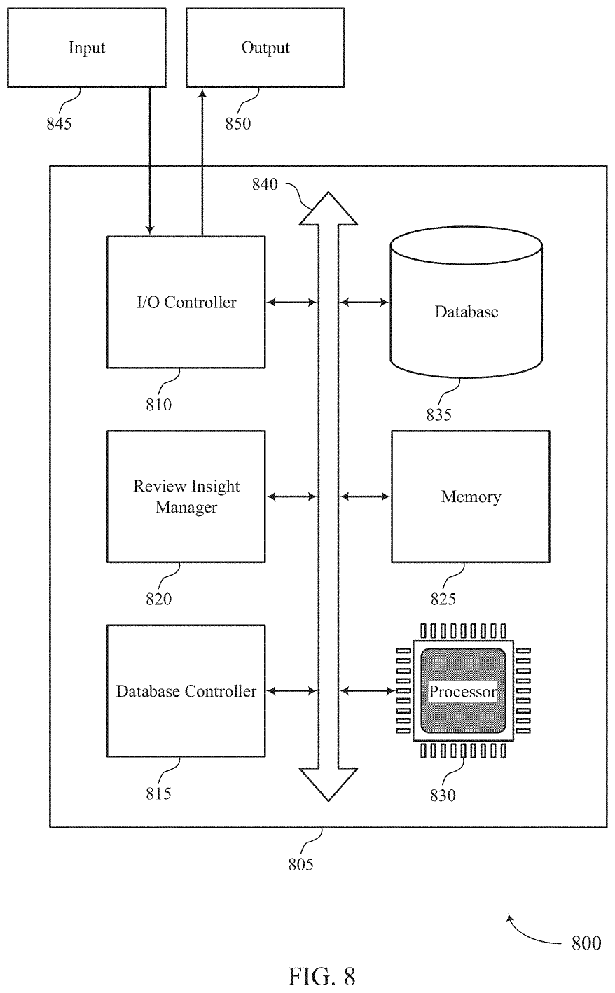

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the review insight manager 620 to support techniques for automated review-based insights. In some cases, the input module 610 may be a component of an I/O controller 810 as described with reference to FIG. 8.

The output module 615 may manage output signals for the device 605. For example, the output module 615 may receive signals from other components of the device 605, such as the review insight manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the review insight manager 620 may include a review identification component 625, a user interface component 630, a user input reception component 635, a textual comparison component 640, or any combination thereof. In some examples, the review insight manager 620, or various components thereof, may be configured to perform various operations (e.g., receiving, monitoring, transmitting) using or otherwise in cooperation with the input module 610, the output module 615, or both. For example, the review insight manager 620 may receive information from the input module 610, send information to the output module 615, or be integrated in combination with the input module 610, the output module 615, or both to receive information, transmit information, or perform various other operations as described herein.

The review insight manager 620 may support deriving relationships from user-submitted reviews in accordance with examples as disclosed herein. The review identification component 625 may be configured as or otherwise support a means for identifying, by one or more processors, a set of reviews for a first product available on a network-based marketplace. The user interface component 630 may be configured as or otherwise support a means for causing presentation of a product listing for the first product in a GUI of a client device, the product listing comprising one or more reviews from the set of reviews for the first product. The user input reception component 635 may be configured as or otherwise support a means for receiving, via the client device, a user input corresponding to text included in a first review for the first product from the set of reviews. The textual comparison component 640 may be configured as or otherwise support a means for determining, by the one or more processors, one or more additional products available on the network-based marketplace based at least in part on textual similarity or dissimilarity between a portion of the text included in the first review and text included in one or more reviews for the one or more additional products. The user interface component 630 may be configured as or otherwise support a means for causing presentation of one or more product listings for the one or more additional products in the GUI of the client device.

By way of another example, the review identification component 625 may be configured as or otherwise support a means for identifying, by one or more processors, a set of reviews for a first listing (e.g., product listing, service listing, business listing, buyer/seller listing). The user interface component 630 may be configured as or otherwise support a means for causing presentation of a the first listing a GUI of a client device, the first listing comprising one or more reviews from the set of reviews. The user input reception component 635 may be configured as or otherwise support a means for receiving, via the client device, a user input corresponding to text included in a first review from the set of reviews. The textual comparison component 640 may be configured as or otherwise support a means for determining, by the one or more processors, one or more additional listings based at least in part on textual similarity or dissimilarity between a portion of the text included in the first review and text included in one or more reviews for the one or more additional listings. The user interface component 630 may be configured as or otherwise support a means for causing presentation of one or more additional listings in the GUI of the client device.

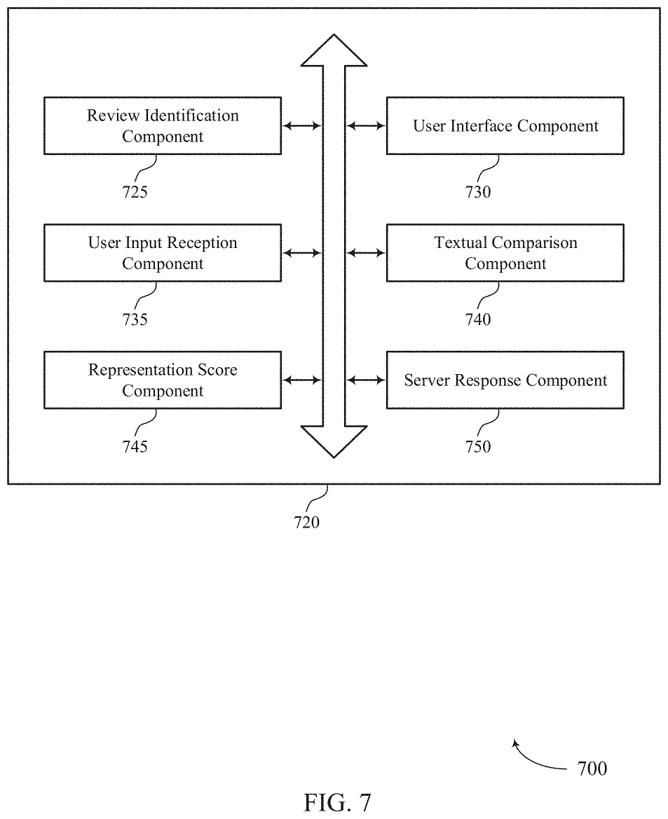

FIG. 7 shows a block diagram 700 of a review insight manager 720 that supports techniques for automated review-based insights in accordance with aspects of the present disclosure. The review insight manager 720 may be an example of aspects of a review insight manager or a review insight manager 620, or both, as described herein. The review insight manager 720, or various components thereof, may be an example of means for performing various aspects of techniques for automated review-based insights as described herein. For example, the review insight manager 720 may include a review identification component 725, a user interface component 730, a user input reception component 735, a textual comparison component 740, a representation score component 745, a server response component 750, or any combination thereof. Each of these components may communicate, directly or indirectly, with one another (e.g., via one or more buses).

The review insight manager 720 may support deriving relationships from user-submitted reviews in accordance with examples as disclosed herein. The review identification component 725 may be configured as or otherwise support a means for identifying, by one or more processors, a set of reviews for a first product available on a network-based marketplace. The user interface component 730 may be configured as or otherwise support a means for causing presentation of a product listing for the first product in a GUI of a client device, the product listing comprising one or more reviews from the set of reviews for the first product. The user input reception component 735 may be configured as or otherwise support a means for receiving, via the client device, a user input corresponding to text included in a first review for the first product from the set of reviews. The textual comparison component 740 may be configured as or otherwise support a means for determining, by the one or more processors, one or more additional products available on the network-based marketplace based at least in part on textual similarity between a portion of the text included in the first review and text included in one or more reviews for the one or more additional products. In some examples, the user interface component 730 may be configured as or otherwise support a means for causing presentation of one or more product listings for the one or more additional products in the GUI of the client device.

In some examples, the review identification component 725 may be configured as or otherwise support a means for selecting, by the one or more processors, a first subset of the set of reviews for the first product based at least in part on textual similarity between at least the portion of the text included in the first review and text included in the first subset of the set of reviews. In some examples, the user interface component 730 may be configured as or otherwise support a means for causing presentation of the first subset of the set of reviews in the GUI of the client device based at least in part on selecting the first subset of the set of reviews.

In some examples, the user input selects the portion of the text included in the first review related to a product feature of the first product. In some examples, the selecting is based at least in part on textual similarity between the portion of the text included in the first review related to the product feature and text included in the first subset of the set of reviews related to the product feature.

In some examples, the review identification component 725 may be configured as or otherwise support a means for selecting, by the one or more processors, a second subset of the set of reviews for the first product based at least in part on textual dissimilarity between at least the portion of the text included in the first review and text included in the second subset of the set of reviews. In some examples, the user interface component 730 may be configured as or otherwise support a means for causing presentation of the second subset of the set of reviews in the GUI of the client device based at least in part on selecting the second subset of the set of reviews.

In some examples, the representation score component 745 may be configured as or otherwise support a means for generating, by the one or more processors, a representation score for the first review for the first product, wherein the representation score indicates a proportion of the set of reviews which are represented by the first review. In some examples, the user interface component 730 may be configured as or otherwise support a means for causing presentation of the representation score for the first review in the GUI of the client device.

In some examples, the user interface component 730 may be configured as or otherwise support a means for causing presentation, in the GUI of the client device, an indication of a first quantity of reviews from the set of reviews that are similar to the first review based at least in part on textual similarity between at least the portion of the text included in the first review and text included in the first quantity of reviews. In some examples, the user interface component 730 may be configured as or otherwise support a means for causing presentation, in the GUI of the client device, an indication of a second quantity of reviews from the set of reviews that are dissimilar to the first review based at least in part on textual dissimilarity between at least the portion of the text included in the first review and text included in the second quantity of reviews.

In some examples, the server response component 750 may be configured as or otherwise support a means for transmitting the product listing to the client device via a first response, wherein causing presentation of the product listing for the first product in the GUI of the client device is based at least in part on transmitting the first response. In some examples, the server response component 750 may be configured as or otherwise support a means for transmitting the one or more additional products to the client device via a second response based at least in part on receiving the user input, wherein causing presentation of the one or more product listings for the one or more additional products in the GUI of the client device is based at least in part on transmitting the second response.

FIG. 8 shows a diagram of a system 800 including a device 805 that supports techniques for automated review-based insights in accordance with aspects of the present disclosure. The device 805 may be an example of or include the components of a device 605 as described herein. The device 805 may include components for bi-directional data communications including components for transmitting and receiving communications, such as a review insight manager 820, an I/O controller 810, a database controller 815, a memory 825, a processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The 0database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor 830 to perform various functions described herein. In some cases, the memory 825 may contain, among other things, a basic I/O system (BIOS) which may control basic hardware or software operation such as the interaction with peripheral components or devices.

The processor 830 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting techniques for automated review-based insights).

The review insight manager 820 may support deriving relationships from user-submitted reviews in accordance with examples as disclosed herein. For example, the review insight manager 820 may be configured as or otherwise support a means for identifying, by one or more processors, a set of reviews for a first product available on a network-based marketplace. The review insight manager 820 may be configured as or otherwise support a means for causing presentation of a product listing for the first product in a GUI of a client device, the product listing comprising one or more reviews from the set of reviews for the first product. The review insight manager 820 may be configured as or otherwise support a means for receiving, via the client device, a user input corresponding to text included in a first review for the first product from the set of reviews. The review insight manager 820 may be configured as or otherwise support a means for determining, by the one or more processors, one or more additional products available on the network-based marketplace based at least in part on textual similarity between a portion of the text included in the first review and text included in one or more reviews for the one or more additional products. The review insight manager 820 may be configured as or otherwise support a means for causing presentation of one or more product listings for the one or more additional products in the GUI of the client device.

By including or configuring the review insight manager 820 in accordance with examples as described herein, the device 805 may support techniques for improved review-based insights. Techniques described herein may derive relationships between reviews and other feedback to provide more helpful and insightful reviews and products to a user. In particular, techniques described herein may compare text across reviews for products to identify similar and/or dissimilar reviews, as well as similar/dissimilar products. In this regard, techniques described herein may enable users to quickly and efficiently sort through reviews based on features or characteristics which are important to the user, which may reduce a quantity of reviews the user must sort through, thereby improving overall user experience. Additionally, techniques described herein may improve product recommendations which are provided to the user, which may improve a frequency and probability that the user will purchase recommended products.

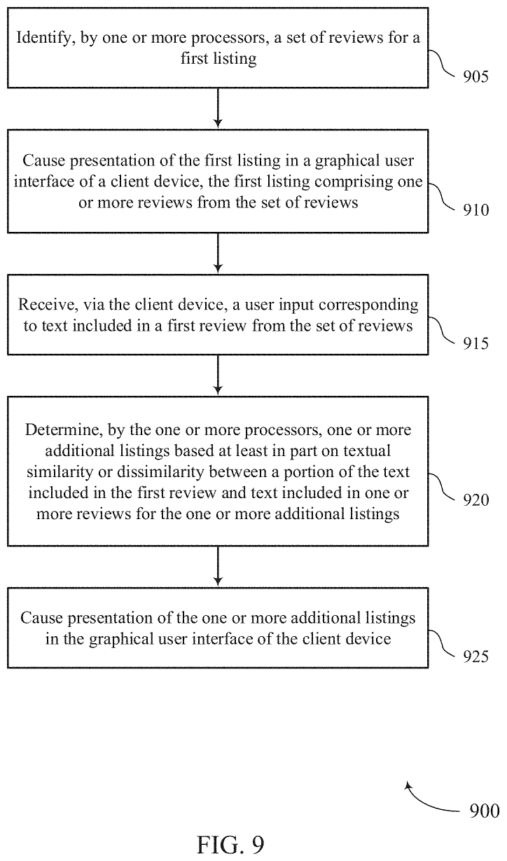

FIG. 9 shows a flowchart illustrating a method 900 that supports techniques for automated review-based insights in accordance with aspects of the present disclosure. The operations of the method 900 may be implemented by a device or its components as described herein. For example, the operations of the method 900 may be performed by a device as described with reference to FIGS. 1 through 8. In some examples, a device may execute a set of instructions to control the functional elements of the device to perform the described functions. Additionally or alternatively, the device may perform aspects of the described functions using special-purpose hardware.

At 905, the method may include identifying, by one or more processors, a set of reviews for a first listing. The operations of 905 may be performed in accordance with examples as disclosed herein. In some examples, aspects of the operations of 905 may be performed by a review identification component 725 as described with reference to FIG. 7.

At 910, the method may include causing presentation of the first listing in a GUI of a client device, the first listing comprising one or more reviews from the set of reviews. The operations of 910 may be performed in accordance with examples as disclosed herein. In some examples, aspects of the operations of 910 may be performed by a user interface component 730 as described with reference to FIG. 7.

At 915, the method may include receiving, via the client device, a user input corresponding to text included in a first review from the set of reviews. The operations of 915 may be performed in accordance with examples as disclosed herein. In some examples, aspects of the operations of 915 may be performed by a user input reception component 735 as described with reference to FIG. 7.

At 920, the method may include determining, by the one or more processors, one or more additional listings based at least in part on textual similarity or dissimilarity between a portion of the text included in the first review and text included in one or more reviews for the one or more additional listings. The operations of 920 may be performed in accordance with examples as disclosed herein. In some examples, aspects of the operations of 920 may be performed by a textual comparison component 740 as described with reference to FIG. 7.

At 925, the method may include causing presentation of the one or more additional listings in the GUI of the client device. The operations of 925 may be performed in accordance with examples as disclosed herein. In some examples, aspects of the operations of 925 may be performed by a user interface component 730 as described with reference to FIG. 7.

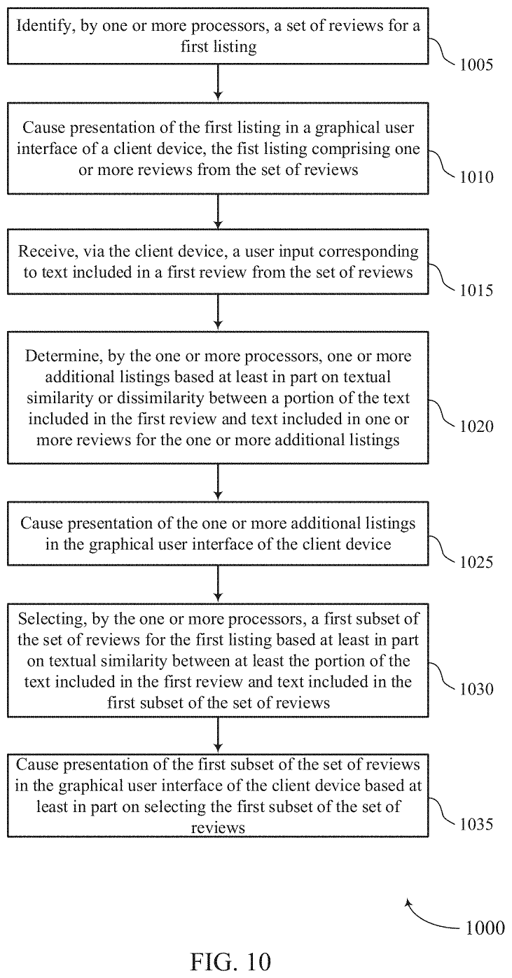

FIG. 10 shows a flowchart illustrating a method 1000 that supports techniques for automated review-based insights in accordance with aspects of the present disclosure. The operations of the method 1000 may be implemented by a device or its components as described herein. For example, the operations of the method 1000 may be performed by a device as described with reference to FIGS. 1 through 8. In some examples, a device may execute a set of instructions to control the functional elements of the device to perform the described functions. Additionally or alternatively, the device may perform aspects of the described functions using special-purpose hardware.

At 1005, the method may include identifying, by one or more processors, a set of reviews for a first listing. The operations of 1005 may be performed in accordance with examples as disclosed herein. In some examples, aspects of the operations of 1005 may be performed by a review identification component 725 as described with reference to FIG. 7.

At 1010, the method may include causing presentation of the first listing in a GUI of a client device, the product listing comprising one or more reviews from the set of reviews. The operations of 1010 may be performed in accordance with examples as disclosed herein. In some examples, aspects of the operations of 1010 may be performed by a user interface component 730 as described with reference to FIG. 7.

At 1015, the method may include receiving, via the client device, a user input corresponding to text included in a first review for the first listing from the set of reviews. The operations of 1015 may be performed in accordance with examples as disclosed herein. In some examples, aspects of the operations of 1015 may be performed by a user input reception component 735 as described with reference to FIG. 7.

At 1020, the method may include determining, by the one or more processors, one or more additional listings based at least in part on textual similarity or dissimilarity between a portion of the text included in the first review and text included in one or more reviews for the one or more additional listings. The operations of 1020 may be performed in accordance with examples as disclosed herein. In some examples, aspects of the operations of 1020 may be performed by a textual comparison component 740 as described with reference to FIG. 7.

At 1025, the method may include causing presentation of the one or more additional listings in the GUI of the client device. The operations of 1025 may be performed in accordance with examples as disclosed herein. In some examples, aspects of the operations of 1025 may be performed by a user interface component 730 as described with reference to FIG. 7.

At 1030, the method may include selecting, by the one or more processors, a first subset of the set of reviews for the first listing based at least in part on textual similarity between at least the portion of the text included in the first review and text included in the first subset of the set of reviews. The operations of 1030 may be performed in accordance with examples as disclosed herein. In some examples, aspects of the operations of 1030 may be performed by a review identification component 725 as described with reference to FIG. 7.

At 1035, the method may include causing presentation of the first subset of the set of reviews in the GUI of the client device based at least in part on selecting the first subset of the set of reviews. The operations of 1035 may be performed in accordance with examples as disclosed herein. In some examples, aspects of the operations of 1035 may be performed by a user interface component 730 as described with reference to FIG. 7.

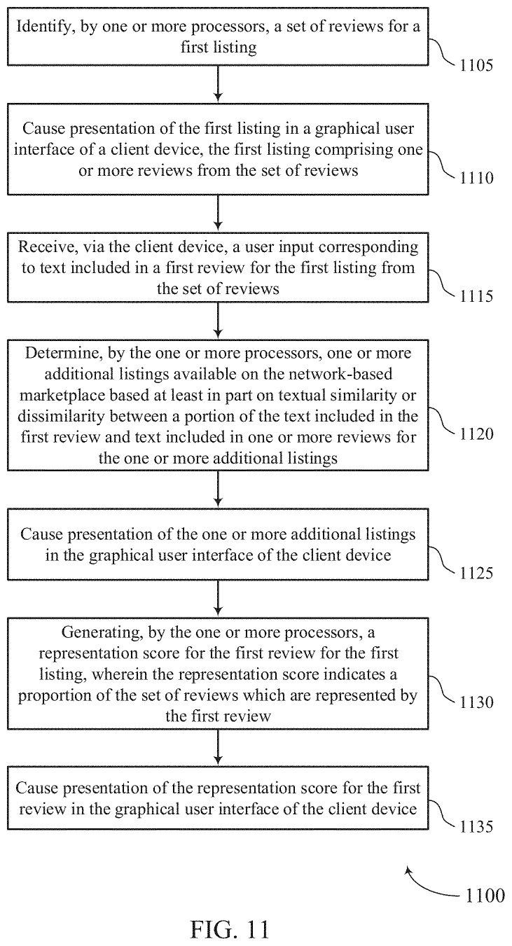

FIG. 11 shows a flowchart illustrating a method 1100 that supports techniques for automated review-based insights in accordance with aspects of the present disclosure. The operations of the method 1100 may be implemented by a device or its components as described herein. For example, the operations of the method 1100 may be performed by a device as described with reference to FIGS. 1 through 8. In some examples, a device may execute a set of instructions to control the functional elements of the device to perform the described functions. Additionally or alternatively, the device may perform aspects of the described functions using special-purpose hardware.

At 1105, the method may include identifying, by one or more processors, a set of reviews for a first listing. The operations of 1105 may be performed in accordance with examples as disclosed herein. In some examples, aspects of the operations of 1105 may be performed by a review identification component 725 as described with reference to FIG. 7.

At 1110, the method may include causing presentation of the first listing in a GUI of a client device, the product listing comprising one or more reviews from the set of reviews. The operations of 1110 may be performed in accordance with examples as disclosed herein. In some examples, aspects of the operations of 1110 may be performed by a user interface component 730 as described with reference to FIG. 7.

At 1115, the method may include receiving, via the client device, a user input corresponding to text included in a first review from the set of reviews. The operations of 1115 may be performed in accordance with examples as disclosed herein. In some examples, aspects of the operations of 1115 may be performed by a user input reception component 735 as described with reference to FIG. 7.

At 1120, the method may include determining, by the one or more processors, one or more additional listings based at least in part on textual similarity or dissimilarity between a portion of the text included in the first review and text included in one or more reviews for the one or more additional listings. The operations of 1120 may be performed in accordance with examples as disclosed herein. In some examples, aspects of the operations of 1120 may be performed by a textual comparison component 740 as described with reference to FIG. 7.

At 1125, the method may include causing presentation of the one or more additional listings in the GUI of the client device. The operations of 1125 may be performed in accordance with examples as disclosed herein. In some examples, aspects of the operations of 1125 may be performed by a user interface component 730 as described with reference to FIG. 7.

At 1130, the method may include generating, by the one or more processors, a representation score for the first review for the first listing, wherein the representation score indicates a proportion of the set of reviews which are represented by the first review. The operations of 1130 may be performed in accordance with examples as disclosed herein. In some examples, aspects of the operations of 1130 may be performed by a representation score component 745 as described with reference to FIG. 7.

At 1135, the method may include causing presentation of the representation score for the first review in the GUI of the client device. The operations of 1135 may be performed in accordance with examples as disclosed herein. In some examples, aspects of the operations of 1135 may be performed by a user interface component 730 as described with reference to FIG. 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method for deriving relationships from user-submitted reviews, comprising:
identifying, by one or more processors, a set of reviews for a first listing;
causing presentation of the first listing in a graphical user interface of a client device, the first listing comprising one or more reviews from the set of reviews;
receiving, via the client device, a user input corresponding to text included in a first review from the set of reviews;
determining, by the one or more processors, one or more additional listings based at least in part on textual similarity or dissimilarity between a portion of the text included in the first review and text included in one or more reviews for the one or more additional listings; and
causing presentation of the one or more additional listings in the graphical user interface of the client device.

2. The computer-implemented method of claim 1, further comprising:
selecting, by the one or more processors, a first subset of the set of reviews for the first listing based at least in part on textual similarity between at least the portion of the text included in the first review and text included in the first subset of the set of reviews; and
causing presentation of the first subset of the set of reviews in the graphical user interface of the client device based at least in part on selecting the first subset of the set of reviews.

3. The computer-implemented method of claim 2, wherein the user input selects the portion of the text included in the first review related to a listing feature of the first listing, and wherein selecting the first subset of the set of reviews is based at least in part on textual similarity between the portion of the text included in the first review related to the listing feature and text included in the first subset of the set of reviews related to the listing feature.

4. The computer-implemented method of claim 2, further comprising:
selecting, by the one or more processors, a second subset of the set of reviews for the first listing based at least in part on textual dissimilarity between at least the portion of the text included in the first review and text included in the second subset of the set of reviews; and
causing presentation of the second subset of the set of reviews in the graphical user interface of the client device based at least in part on selecting the second subset of the set of reviews.

5. The computer-implemented method of claim 1, further comprising:
generating, by the one or more processors, a representation score for the first review for the first listing, wherein the representation score indicates a proportion of the set of reviews which are represented by the first review; and
causing presentation of the representation score for the first review in the graphical user interface of the client device.

6. The computer-implemented method of claim 1, further comprising:
generating, by the one or more processors, a representation score for each review of the set of reviews, wherein the representation scores indicate a proportion of the set of reviews which are represented by each respective review;
receiving, via the client device, an instruction to sort the one or more reviews based at least in part on the representation score for each of the one or more reviews; and
causing presentation of the one or more reviews on the graphical user interface of the client device based at least in part on receiving the instruction and the representation score for each review of the one or more reviews.

7. The computer-implemented method of claim 1, further comprising:
causing presentation, in the graphical user interface of the client device, an indication of a first quantity of reviews from the set of reviews that are similar to the first review based at least in part on textual similarity between at least the portion of the text included in the first review and text included in the first quantity of reviews; and
causing presentation, in the graphical user interface of the client device, an indication of a second quantity of reviews from the set of reviews that are dissimilar to the first review based at least in part on textual dissimilarity between at least the portion of the text included in the first review and text included in the second quantity of reviews.

8. The computer-implemented method of claim 1, further comprising:
transmitting the listing to the client device via a first response, wherein causing presentation of the listing in the graphical user interface of the client device is based at least in part on transmitting the first response; and
transmitting the one or more additional listings to the client device via a second response based at least in part on receiving the user input, wherein causing presentation of the one or more additional listings in the graphical user interface of the client device is based at least in part on transmitting the second response.

9. The computer-implemented method of claim 1, wherein the first listing is associated with a product, a service, a business, a seller, a buyer, or an entity.

10. A system for deriving relationships from user-submitted reviews, comprising:
one or more processors; and
a computer-readable medium storing instructions that, when executed by the one or more processors, cause the system to perform operations comprising:
identifying a set of reviews for a first listing;
causing presentation of the first listing in a graphical user interface of a client device, the listing comprising one or more reviews from the set of reviews;
receiving, via the client device, a user input corresponding to text included in a first review from the set of reviews;
determining one or more additional listings based at least in part on textual similarity or dissimilarity between a portion of the text included in the first review and text included in one or more reviews for the one or more additional listings; and
causing presentation of the one or more additional listings in the graphical user interface of the client device.

11. The system of claim 10, wherein the instructions are further executable by the one or more processors to cause the system to perform operations comprising:
selecting, by the one or more processors, a first subset of the set of reviews for the first listing based at least in part on textual similarity between at least the portion of the text included in the first review and text included in the first subset of the set of reviews; and
causing presentation of the first subset of the set of reviews in the graphical user interface of the client device based at least in part on selecting the first subset of the set of reviews.

12. The system of claim 11, wherein the user input selects the portion of the text included in the first review related to a listing feature of the first listing, and wherein selecting the first subset of the set of reviews is based at least in part on textual similarity between the portion of the text included in the first review related to the listing feature and text included in the first subset of the set of reviews related to the listing feature.

13. The system of claim 11, wherein the instructions are further executable by the one or more processors to cause the system to perform operations comprising:
selecting, by the one or more processors, a second subset of the set of reviews for the first listing based at least in part on textual dissimilarity between at least the portion of the text included in the first review and text included in the second subset of the set of reviews; and
causing presentation of the second subset of the set of reviews in the graphical user interface of the client device based at least in part on selecting the second subset of the set of reviews.

14. The system of claim 10, wherein the instructions are further executable by the one or more processors to cause the system to perform operations comprising:
generating, by the one or more processors, a representation score for the first review for the first listing, wherein the representation score indicates a proportion of the set of reviews which are represented by the first review; and
causing presentation of the representation score for the first review in the graphical user interface of the client device.

15. The system of claim 10, wherein the instructions are further executable by the one or more processors to cause the system to perform operations comprising:
causing presentation, in the graphical user interface of the client device, an indication of a first quantity of reviews from the set of reviews that are similar to the first review based at least in part on textual similarity between at least the portion of the text included in the first review and text included in the first quantity of reviews; and
causing presentation, in the graphical user interface of the client device, an indication of a second quantity of reviews from the set of reviews that are dissimilar to the first review based at least in part on textual dissimilarity between at least the portion of the text included in the first review and text included in the second quantity of reviews.

16. The system of claim 10, wherein the instructions are further executable by the one or more processors to cause the system to perform operations comprising:
transmitting the first listing to the client device via a first response, wherein causing presentation of the first listing in the graphical user interface of the client device is based at least in part on transmitting the first response; and
transmitting the one or more additional listings to the client device via a second response based at least in part on receiving the user input, wherein causing presentation of the one or more additional listings in the graphical user interface of the client device is based at least in part on transmitting the second response.

17. A non-transitory computer-readable medium for deriving relationships from user-submitted reviews, storing instructions which, when executed by a processor, cause the processor to perform operations comprising:
identifying a set of reviews for a first listing;
causing presentation of the first listing in a graphical user interface of a client device, the first listing comprising one or more reviews from the set of reviews;
receiving, via the client device, a user input corresponding to text included in a first review from the set of reviews;
determining one or more additional listings based at least in part on textual similarity or dissimilarity between a portion of the text included in the first review and text included in one or more reviews for the one or more additional listings; and
causing presentation of the one or more additional listings in the graphical user interface of the client device.

18. The non-transitory computer-readable medium of claim 17, the operations further comprising:
selecting, by the one or more processors, a first subset of the set of reviews for the first listing based at least in part on textual similarity between at least the portion of the text included in the first review and text included in the first subset of the set of reviews; and
causing presentation of the first subset of the set of reviews in the graphical user interface of the client device based at least in part on selecting the first subset of the set of reviews.

19. The non-transitory computer-readable medium of claim 18, wherein the user input selects the portion of the text included in the first review related to a listing feature of the first listing, and wherein selecting the first subset of the set of reviews is based at least in part on textual similarity between the portion of the text included in the first review related to the listing feature and text included in the first subset of the set of reviews related to the listing feature.

20. The non-transitory computer-readable medium of claim 18, the operations further comprising:
selecting, by the one or more processors, a second subset of the set of reviews for the first listing based at least in part on textual dissimilarity between at least the portion of the text included in the first review and text included in the second subset of the set of reviews; and
causing presentation of the second subset of the set of reviews in the graphical user interface of the client device based at least in part on selecting the second subset of the set of reviews.
